(19) United States
(12) Patent Application Publication
(10) Pub. No.: US 2010/0323738 A1
(43) Pub. Date: Dec. 23, 2010

(54) MOBILE STATION APPARATUS AND COMMUNICATION METHOD

(75) Inventors: Tatsushi Aiba, Osaka-shi (JP); Chongguang Yan, Osaka-shi (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA, Osaka-shi (JP)

(21) Appl. No.: 12/864,931

(22) PCT Filed: Jan. 29, 2009
(86) PCT No.: PCT/JP2009/051432

§ 371 Date: Jul. 28, 2010

(30) Foreign Application Priority Data
Jan. 29, 2008 (JP) 2008-018195

(51) Int. Cl. H04B 7/00

(52) U.S. Cl. 455/509

(57) ABSTRACT

In case of receiving the L1/L2 grant for permitting the data transmission on the uplink to multiple PUCCH subframes assigned to transmit the reception quality information, the mobile station apparatus transmits all the reception quality information that was attempted to be transmitted by using the multiple PUCCH subframes, by using the corresponding single PUSCH subframe. As a result, it is possible to provide the mobile station apparatus and the like with which, in case that the base station apparatus transmits the L1/L2 grant to multiple PUCCH subframes that were assigned to the mobile station apparatus to transmit the reception quality information, the transmission and reception processing of the reception quality information performed between the base station apparatus and the mobile station apparatus can be reduced, and appropriate communication control following the conditions of the current transmission channel can be achieved by reducing the delay occurring when the mobile station apparatus transmits the reception quality information.

### TECHNICAL FIELD

The present invention relates to a mobile station apparatus and the like that is assigned with resources from a base station apparatus based on reception quality information.

### BACKGROUND ART

Recently, in the field of mobile communication system, the demand for data communication has been increased. With this, various technologies which can produce high frequency usage efficiency so as to deal with the increased amount of communication data accompanied by the demand for data communication have been proposed. As one of the technologies to increase frequency usage efficiency, OFDMA (Orthogonal Frequency Division Multiple Access) is used. This OFDMA relates to a technology of modulation scheme used when communication is performed using an identical frequency in all the cells in a communication area formed of the cells, and can realize high-speed data communication.

In scheduling of transmission packets in the OFDMA system, there is a known method in which CQI (Channel Quality Indicator) as information indicating reception quality of the downlink state in a wideband subcarrier is transmitted from mobile station apparatuses to the base station apparatus and the base station apparatus performs packet scheduling based on the CQI of the wideband subcarrier transmitted from each mobile station apparatus.

Further, in scheduling of transmission packets in an OFDM (Orthogonal Frequency Division Multiplexing) system using multiple subcarriers, there is also a known method in which each downstream channel state (frequency characteristics, i.e., characteristics such as transmission loss and the like that depend on frequency) is evaluated at mobile station apparatuses and the quantized information of each channel state is transmitted to the base station apparatus so that the base station apparatus determines subcarriers to be assigned to each mobile station apparatus based on the transmitted information.

FIG. 8 is a diagram for illustrating a conventional communication method between the base station apparatus and the mobile station apparatus. The mobile station apparatus having received downlink information of the downstream channel to be used for reception quality measurement, from the base station apparatus, measures the reception quality of each channel based on the downlink information to prepare a channel profile of the transmission channel.

The channel profile prepared by the mobile station apparatus is transmitted as the reception quality information from the mobile station apparatus to the base station apparatus by using an upstream channel. Based on the reception quality information, the base station apparatus performs processes of the adaptive modulation and coding scheme or the frequency selective scheduling, for the signals to be transmitted from the base station apparatus to the mobile station apparatus.

As to this transmission of the reception quality information from the mobile station apparatus to the base station apparatus, single carrier communication system based on the DFT (Discrete Fourier Transform)-spread-OFDM scheme have been proposed as information communication system on the uplink in the evolution of the third generation radio access (Evolved Universal Terrestrial Radio Access) which has been studies by 3GPP (3rd Generation Partnership Project) as an international standardizing projection, and investigation of transmission from the mobile station apparatus to the base station apparatus by using dedicated uplink control channel PUCCH (Physical Uplink Control Channel) or uplink data channel PUSCH (Physical Uplink Shared Channel) is in progress.

The procedure for transmission and reception of the reception quality information between the base station apparatus and the mobile station apparatus by using PUCCH and PUSCH will be described.

First, the base station apparatus assigns, to the mobile station apparatus, a long-term PUCCH resources for transmitting the reception quality information. The mobile station apparatus periodically transmits the reception quality information by using the assigned PUCCH resources. However, in this case, in case that an uplink data transmission grant signal (which will be referred to hereinbelow as “L1/L2 grant”) that indicates permission of data transmission for the uplink is transmitted from the base station apparatus, the mobile station apparatus transmits the reception quality information together with an uplink data (or the reception quality information only) by using PUSCH resources that are assigned by the L1/L2 grant instead of using the previously assigned PUCCH resources.

The mobile station apparatus transmits the uplink data in accordance with the resources allocation indicated by the downlink control channel PDCCH (Physical Downlink Control Channel from the base station apparatus. That is, this downlink control channel PDCCH is the signal L1/L2 grant that permits data transmission for the uplink.

In general, since the resources region assigned as PUCCH by the base station apparatus is smaller than the resources region assigned thereby as PUSCH, the size of information amount of being transmitted becomes small. That is, the reception quality information transmitted, by using PUCCH, by the mobile station apparatus is the reception quantity information of small information amount while the reception quality information transmitted, by using PUSCH, is the reception quantity information of large information amount.

The base station apparatus performs the processes of the adaptive modulation and coding scheme or the frequency selective scheduling etc. for the signals to be transmitted to the mobile station apparatus based on the reception quality information transmitted from the mobile station apparatus. For example, in case that the mobile station apparatus transmits the reception quality information of small information amount, the base station apparatus will transmit, to the mobile station apparatus, a signal that has not been performed the processes of high-accuracy adaptive modulation and coding scheme or the frequency selective scheduling etc., or that has been performed the processes of the adaptive modulation and coding scheme only, depending on the information amount.

On the other hand, in case that the mobile station apparatus transmits the reception quality information of large information amount, the base station apparatus transmits, to the mobile station apparatus, a signal which has been performed the processes of high-accuracy adaptive modulation and coding scheme or the frequency selective scheduling etc., based on that information.

In this way, in case that the reception quality information of large information amount is transmitted from the mobile station apparatus, the base station apparatus can perform high-accuracy adaptive modulation and coding scheme or the frequency selective scheduling etc. for the signal to be transmitted. As a result, it is possible to efficiently perform communication control (scheduling) between the base station apparatus and the mobile station apparatus.

With respect to this, in order to transmit the reception quality information of large information amount by using PUCCH from the mobile station apparatus, the following non-patented document 1, for example, proposes transmission of large amount reception quality information by using multiple PUCCH subframes. The proposal is that, for example, three PUCCH subframes are used to transmit 10 bits of information for each so as to transmit the reception quality information of 30 bits.

### Non-Patented Document 1:

“CQI on PUCCH using multiple subframes”, 3GPP, TSG RAN WG1 Meeting #49bis, R1-072797, June 2007.

### DISCLOSURE OF INVENTION

### Problems to be Solved by the Invention

However, in the prior art, if the base station apparatus transmits the L1/L2 grant to multiple PUCCH subframes that the mobile station apparatus uses to transmit large amount reception quality information, the mobile station apparatus transmits only the reception quality information of the corresponding PUCCH subframe by using PUSCH. Hence, there has been the problem that the procedures for transmission and reception of the reception quality information between the base station apparatus and the mobile station apparatus become complicated.

For example, when the reception quality information of 30 bits is attempted to be transmitted by using three PUCCH subframes (the reception quality information of 10 bits is transmitted by each PUCCH subframe, for example), if the base station apparatus has transmitted the L1/L2 grant at the timing corresponding to the first PUCCH subframe, it was necessary for the mobile station apparatus to transmit 10 bits of the reception quality information by using PUSCH in the first subframe and transmit 20 bits of the reception quality information (10 bits for each subframe) by using PUCCH during the remaining two subframes.

That is, it was necessary on the mobile station apparatus side to transmit 30 bits of the reception quality information by using different channels (10 bits by using PUSCH and 20 bits by using PUCCH), and it was necessary on the base station apparatus side to decode different pieces of the reception quality information transmitted by different channels (PUSCH, PUCCH), and then to perform the processes of adaptive modulation control or the frequency selective scheduling for information to be transmitted on the downlink.

Further, in case that the reception quality information of large information amount is transmitted by using the multiple PUCCH subframes, a delay will occur in the transmission of the reception quality information from the mobile station apparatus to the base station apparatus. For example, if the mobile station apparatus can transmit only 10 bits of the reception quality information by a single PUCCH subframe, a delay for 3 subframes will occur in order to transmit the reception quality information of information amount of 30 bits.

If a delay occurs in case that the reception quality information is transmitted from the mobile station apparatus, there occurs the problem that appropriate communication control that follows the conditions of the current transmission channel cannot be done. The mobile station apparatus measures the reception quality information from the information transmitted from the base station apparatus on the downlink and transmits the measured reception quality information to the base station apparatus. In this process, if a large delay occurs, the conditions of the transmission channel change greatly, and the processes of the adaptive modulation and coding scheme or the frequency selective scheduling that are performed in the base station apparatus based on the reception quality information transmitted from the mobile station apparatus become unsuited to the conditions of the current transmission channel, and becomes meaningless.

When the reception quality information measured by the mobile station apparatus is transmitted with a small delay, the base station apparatus can transmit downlink information that has been performed the processes of the adaptive modulation and coding scheme or the frequency selective scheduling suited to the conditions of the current transmission channel, to the mobile station apparatus.

That is, in transmission of the reception quality information from the mobile station apparatus to the base station apparatus, in case that the base station apparatus transmits the L1/L2 grant to multiple PUCCH subframes that were assigned for the mobile station apparatus to transmit the reception quality information, there has been the problem that the procedures for transmission and reception of the reception quality information performed between the base station apparatus and the mobile station apparatus becomes complicated. Further, there occurred the problem that a delay occurs when the reception quality information is transmitted from the mobile station apparatus to the base station apparatus so that the base station apparatus cannot make suitable communication control following the conditions of the current transmission channel.

The present invention has been devised in view of the above circumstances, it is therefore an object of the present invention to provide the mobile station apparatus, the base station apparatus and the mobile communication system which, in case that the base station apparatus transmits the L1/L2 grant to multiple PUCCH subframes assigned for the mobile station apparatus to transmit the reception quality information, reduces the processes for transmission and reception of the reception quality information performed between the base station apparatus and the mobile station apparatus, and enables suitable communication control following the conditions of the current transmission channel by reducing the delay that occurs when the mobile station apparatus transmits the reception quality information.

### Means for Solving the Problems

In order to solve the above problems, a mobile station apparatus of the present invention is a mobile station apparatus to which resources are assigned, by a base station apparatus, based on reception quality information, comprising: uplink data transmission grant signal receiving means for receiving an uplink data transmission grant signal; uplink data transmitting means for transmitting an uplink data by a data channel in case of receiving the uplink data transmission grant signal; and, reception quality transmitting means for transmitting the reception quality information by a control channel, in accordance with a scheduling from the base station apparatus, wherein the reception quality transmitting means, when receiving the uplink transmission grant signal, transmits, to the base station apparatus, all the reception quality information to be transmitted by a corresponding single uplink data channel subframe.

Also, the mobile station apparatus of the present invention further composes subframe number receiving means for receiving, from the base station apparatus, an RRC signaling including the number of transmissible subframes, wherein, when assignment for transmitting the reception quality information is performed within the number of transmissible subframes after reception of the uplink data transmission grant signal, the reception quality transmitting means transmits, to the base station apparatus, all the reception quality information to be transmitted, by the corresponding single uplink data channel subframe.

A base station apparatus of the present invention is a base station apparatus that assigns resources, to a mobile station apparatus, based on reception quality information, comprising: uplink data transmission grant signal transmitting means for transmitting an uplink data transmission grant signal for instructing a mobile station apparatus to transmit the reception quality information that was attempted to be transmitted by multiple control channel subframes, by a single uplink data channel subframe; and, uplink data receiving means for receiving an uplink data by a data channel, wherein the uplink data receiving means is means that receives the reception quality information with the uplink data, from the data channel.

Further, the base station apparatus of the present invention is characterized in that the number of transmissible-subframes is transmitted to the mobile station apparatus by being included in an RRC signaling.

A mobile communication system of the present invention is a mobile communication system connected to a base station apparatus and a mobile station apparatus to which resources are assigned by the base station apparatus based on reception quality information, wherein the base station apparatus comprises: uplink data transmission grant signal transmitting means for transmitting an uplink data transmission grant signal for instructing the mobile station apparatus to transmit the reception quality information that was attempted to be transmitted by multiple control channel subframes, by a single uplink data channel subframe; and, uplink data receiving means for receiving uplink data by the data channel, and the mobile station apparatus comprises: uplink data transmission grant signal receiving means for receiving, from the base station apparatus, the uplink data transmission grant signal; uplink data transmitting means for transmitting an uplink data by the data channel in case of receiving the uplink data transmission grant signal; and, reception quality transmitting means for transmitting the reception quality information by the control channel, in accordance with a scheduling from the base station apparatus, wherein the mobile station apparatus, when receiving the uplink transmission grant signal, transmits all the reception quality information to be transmitted, to the base station apparatus by a corresponding single uplink data channel subframe, and the base station apparatus receives the reception quality information with the uplink data, from the data channel.

### ADVANTAGES OF THE INVENTION

According to the present invention, the object is to reduce the processes for transmission and reception of the reception quality information performed between the base station apparatus and the mobile station apparatus, and enable the base station apparatus to perform suitable communication control (scheduling) following the conditions of the current transmission channel by reducing the delay that occurs when the mobile station apparatus transmits the reception quality information, in case that the base station apparatus transmits the L1/L2 grant to multiple PUCCH subframes that the base station apparatus has assigned to transmit the reception quality information.

### BRIEF DESCRIPTION OF DRAWINGS

FIG. 1 is a diagram showing the outline of a communication system in case that the present invention is applied.

FIG. 2 is a diagram showing a configuration of a base station apparatus in the present embodiment.

FIG. 3 is a diagram showing a configuration of a mobile station apparatus in the present embodiment.

FIG. 4 is a diagram for illustrating operation in the first embodiment.

FIG. 5 is a diagram for illustrating the process in the first embodiment.

FIG. 6 is a diagram for illustrating operation in the second embodiment.

FIG. 7 is a diagram for illustrating the process in the second embodiment.

FIG. 8 is a diagram for illustrating a conventional process.

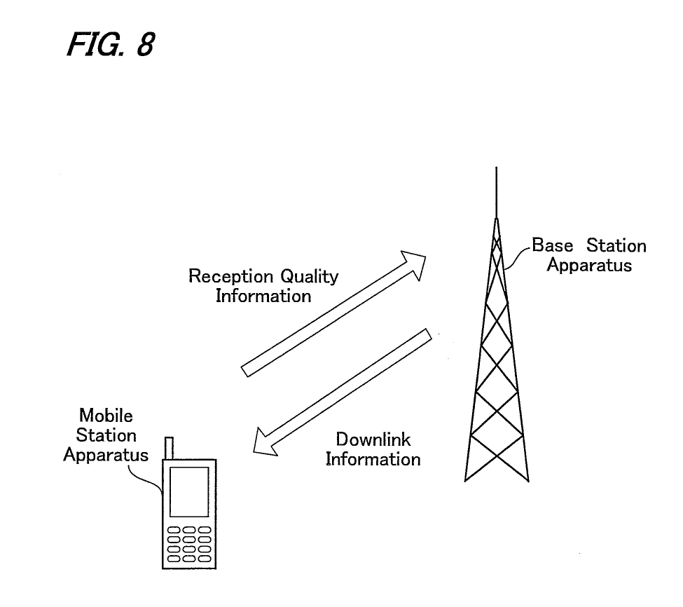

### DESCRIPTION OF REFERENCE NUMERALS

100 Base station apparatus
110 Transmitter
112 Data controller
114 OFDM modulator
116 Radio transmitter
120 Transmission information controller
122 Scheduler unit
124 Modulation and coding controller
126 Frequency selective scheduler unit
130 Receiver
132 Data extractor
134 DFT-s-OFDM demodulator
136 Radio receiver
200 Mobile station apparatus
210 Transmitter
212 Data controller
214 DFT-s-OFDM modulator
216 Radio Transmitter
220 Reception quality information controller
222 Reception quality information generator
224 Reception quality measuring unit
230 Receiver
232 Data extractor
234 OFDM demodulator
236 Radio receiver

### BEST MODE FOR CARRYING OUT THE INVENTION

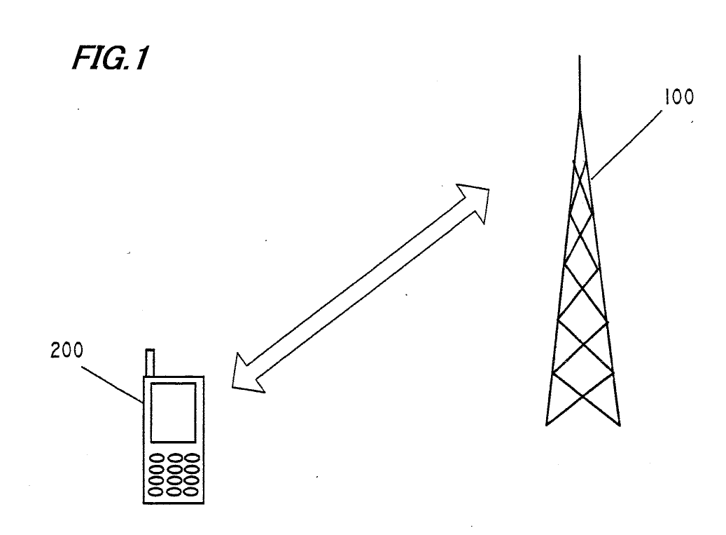

Next, the best mode for carrying out the present invention will be described with reference to the drawings. To begin with, FIG. 1 shows the outline of a communication system including a base station apparatus and a mobile station apparatus when the present invention is applied. The present embodiment will be described on the assumption that a base station apparatus 100 communicates with a mobile station apparatus 200.

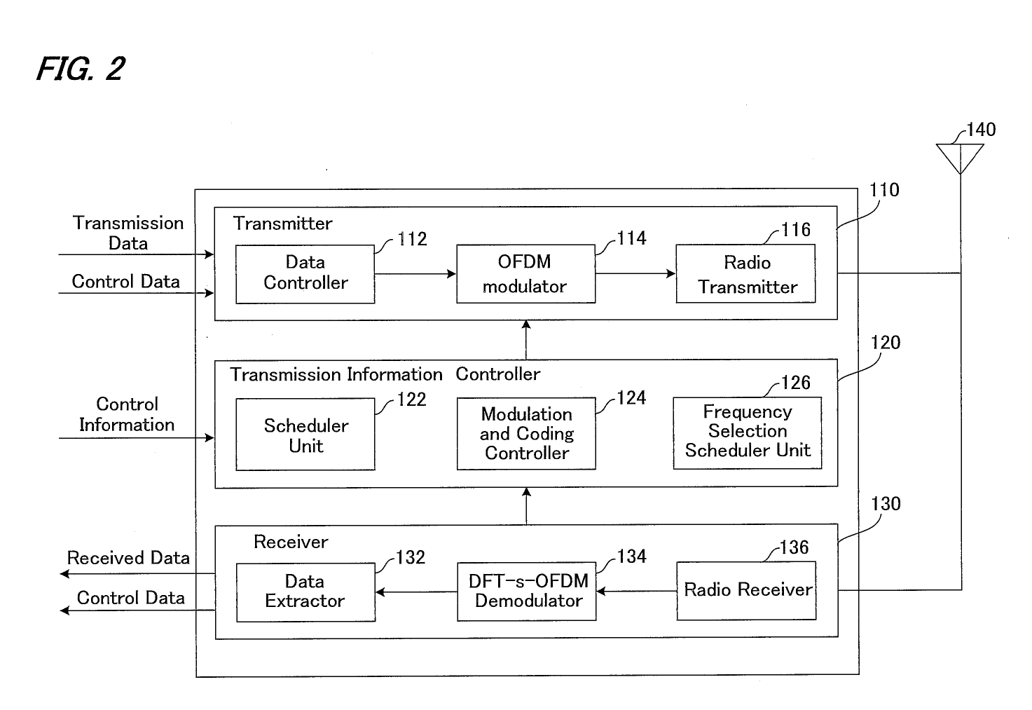

FIG. 2 is a block diagram showing a functional configuration of the base station apparatus 100. As shown in FIG. 2, the base station apparatus 100 composes: a transmitter 110 including a data controller 112, an OFDM modulator 114 and a radio transmitter 116; a transmission information controller 120 including a scheduler unit 122, a modulation and coding controller 124 and a frequency selective scheduler unit 126; and a receiver 130 including a data extractor 132, a DFT-s-OFDM demodulator 134 and a radio receiver 136. An antenna 140 is connected to transmitter 110 and receiver 130.

Here, transmission data and control data are input to the transmitter 110 from the upper layer. Also, received data and control data are output from the receiver 130 to the upper layer.

Transmission data and control data to be transmitted to each mobile station apparatus 200 are input to the data controller 112 and these data are successively output to the OFDM modulator 114 in accordance with the instructions from the transmission information controller 120.

The OFDM modulator 114 performs OFDM signal processing such as data modulation, input signal serial/parallel conversion, FFT (Fast Fourier Transform) transform, CP (Cyclic prefix) insertion, filtering and the like, for the signal input from the data controller 112, and outputs the processed signal to the radio transmitter 116.

The radio transmitter 116 upconverts the signal input from the OFDM modulator 114 into a frequency that is suited to transmission, and transmits the signal to each mobile station apparatus 200 through the antenna 140.

The radio receiver 136 converts the radio signal received from the antenna 140 into a baseband signal and outputs it to the DFT-s-OFDM demodulator 134.

The DFT-s-OFDM demodulator 134 performs DFT-s-OFDM signal processing such as IDFT transform, IFFT transform, filtering and the like, for the signal input from the radio receiver 136, to demodulate the data signal. The demodulated data signal is output to the data extractor 132.

The data extractor 132 extracts the reception quality information from the signal input from the DFT-s-OFDM demodulator 134 and outputs the information to the transmission information controller 120. Received data and control data other than the reception quality information are output to the upper layer and the like.

The transmission information controller 120 controls transmitter 110, based on the control information input from the upper layer and the reception quality information input from the receiver 130.

The scheduler unit 122, based on the control information such as the usable resources area by each mobile station apparatus 200, intermittent transmission/reception cycle, transmission data channel format, buffer status and the like, performs the downlink scheduling and the uplink scheduling.

The modulation and coding controller 124, based on the reception quality information transmitted from the mobile station apparatus 200, determines modulation scheme and coding rate to be applied to each piece of data.

The frequency selective scheduler unit 126, based on the reception quality information transmitted from the mobile station apparatus 200, performs the frequency selective scheduling process for each piece of data.

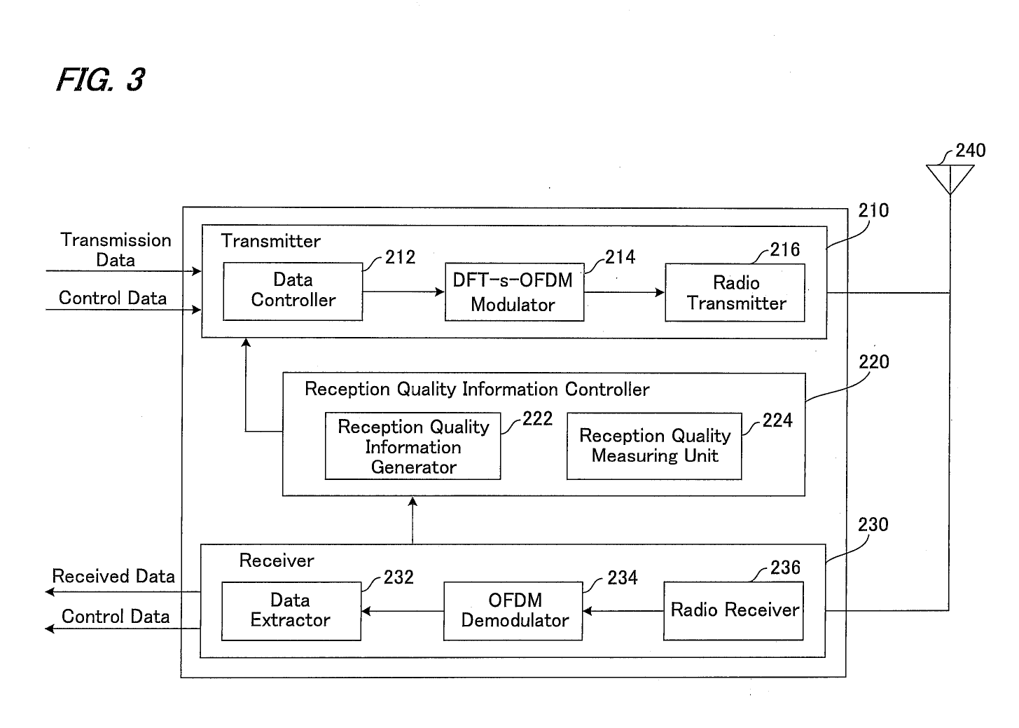

Next, the mobile station apparatus 200 will be described. FIG. 3 is a block diagram for illustrating the functional configuration of the mobile station apparatus 200.

As shown in FIG. 3, the mobile station apparatus 200 composes: a transmitter 210 including a data controller 212, a DFT-s-OFDM modulator 214 and a radio transmitter 216; a reception quality information controller 220 including reception quality information generator 222 and a reception quality information measuring unit 224; and a receiver 230 including a data extractor 232, an OFDM demodulator 234 and a radio receiver 236. An antenna 240 is connected to transmitter 210 and receiver 230.

Here, transmission data and control data are input to the transmitter 210 from the upper layer. Also, received data and control data are output from the receiver 230 to the upper layer.

Transmission data and control data to be transmitted to the base station apparatus 100 are input to the data controller 212 and these data are output to the DFT-s-OFDM modulator 214.

The DFT-s-OFDM modulator 214 performs DFT-s-OFDM signal processing such as data modulation, DFT transform, subcarrier mapping, FFT transform, CP(Cyclic prefix) insertion, filtering and the like for the signal input from the data controller 212, and outputs the processed signal to the radio transmitter 216.

The uplink communication scheme is presumed to be single carrier scheme such as DFT-spread OFDM. The radio transmitter 216 upconverts the signal input from the DFT-s-OFDM modulator 214 into a frequency that is suited to transmission, and transmits the signal to the base station apparatus 100 through the antenna 240.

The radio receiver 236 down-converts the radio signal received from the antenna 240 into a baseband signal and outputs it to the OFDM demodulator 234.

The OFDM demodulator 234 performs OFDM signal processing such as IFFT transform, filtering and the like for the signal input from the radio receiver 236, to demodulate the data signal.

The data extractor 232 extracts the reception quality information for measuring the reception quality information from the data signal input from the OFDM demodulator 234 and outputs the information to the reception quality information controller 220. At this point, received data and control data other than the reception quality information are output to the upper layer and the like.

The reception quality information controller 220 is a functional part that receives the data signal from the receiver 230, extracts the reception quality information and outputs the information to the transmitter 210.

In this configuration, the reception quality measuring unit 224 measures the reception quality from the signal input from the data extractor 232. The reception quality information generator 222, based on information measured by the reception quality measuring unit 224, generates the reception quality information to be transmitted to the base station apparatus 100.

### The First Embodiment

Subsequently, the first embodiment to which the present invention is applied will be described with the base station apparatus 100 and the mobile station apparatus 200 shown in FIGS. 1 to 3.

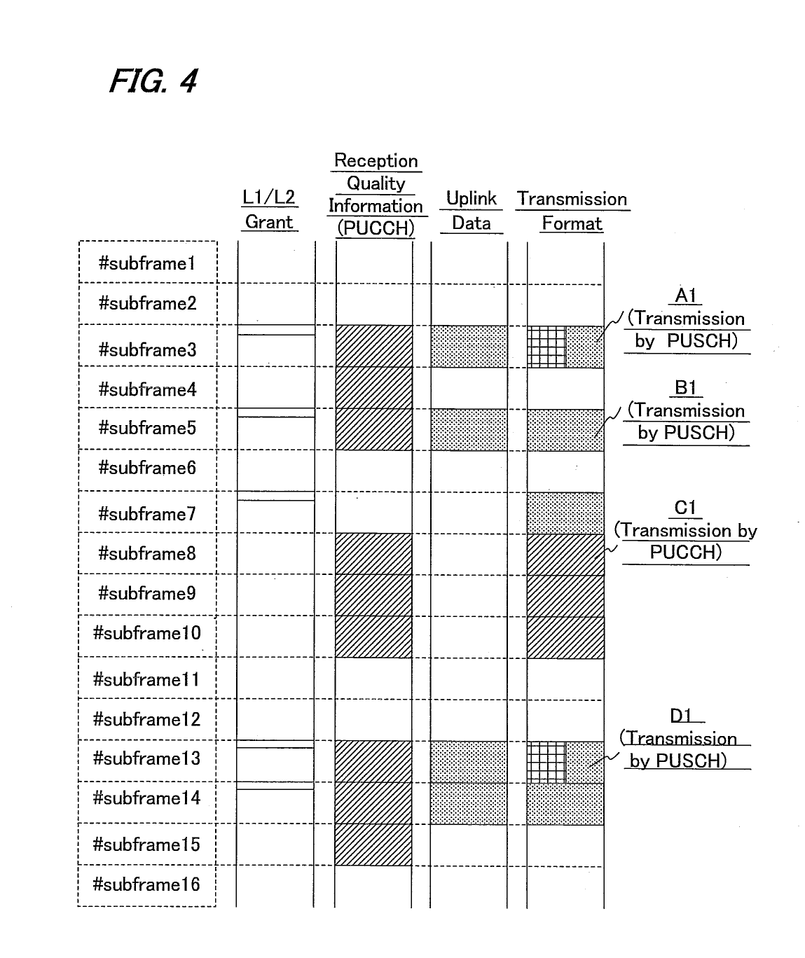

FIG. 4 is a diagram showing control signals (the L1/L2 grants) transmitted from the base station apparatus 100 to the mobile station apparatus 200, the reception quality information transmitted by using PUCCH from the mobile station apparatus 200 to the base station apparatus 100, the uplink data and transmission formats of information transmitted by using the uplink. Here, the operation from #subframe 1 to #subframe 16 is shown as an example.

The L1/L2 grant transmitted from the base station apparatus 100 to the mobile station apparatus 200 is a signal with which the base station apparatus 100 permits the mobile station apparatus 200 data transmission by using the uplink. The base station apparatus 100 can permit the mobile station apparatus 200 to transmit normal uplink data (e.g., user data). Further, it is also possible to permit the mobile station apparatus 200 to transmit the reception quality information by using PUSCH, by including one-bit information in the L1/L2 grant or by using a special L1/L2 grant format.

Further, the base station apparatus 100, by long-term resources assignment, designates the mobile station apparatus 200 to transmit the reception quality information by using the multiple PUCCH subframes. This long-term assignment by the base station apparatus 100 is transmitted by being included in the RRC signaling.

Here, in case that the mobile station apparatus 200 transmits the reception quality information of large amount of information in accordance with the long-term resources assignment from the base station apparatus 100, the mobile station apparatus usually transmits the reception quality information by using the multiple PUCCH subframes. For example, when efficient communication control (scheduling) is realized between the base station apparatus 100 and the mobile station apparatus 200 by transmitting the reception quality information of 30 bits from the mobile station apparatus 200, the reception quality information is transmitted 10 bits in #subframe3, 10 bits in #subframe4 and 10 bits in #subframe5. The base station apparatus 100, based on the transmitted reception quality information of 30 bits in total, performs the processes of the adaptive modulation and coding scheme and the frequency selective scheduling upon the information to be transmitted on the downlink.

In the present embodiment, in case that the base station apparatus 100 transmits the L1/L2 grant for permitting the data transmission on the uplink, to multiple PUCCH subframes assigned to transmit the reception quality information, the mobile station apparatus 200 will transmit all the reception quality information that was attempted to be transmitted by the multiple PUCCH subframes, by using the corresponding single PUSCH subframe. Now, this will be described with reference to FIG. 4.

In illustration of #subframe3, the mobile station apparatus 200 having received the L1/L2 grant from the base station apparatus 100, transmits all the reception quality information that was attempted to be transmitted by use of #subframe3, #subframe4 and #subframe5, together with the uplink data in #subframe3. For example, if it is assumed that the mobile station apparatus 200 was attempted to transmit the reception quality information, 10 bits in #subframe3, 10 bits in #subframe4 and 10 bits in #subframe 5, in accordance with the long-term resources assignment, 30 bits of the reception quality information is transmitted to the base station apparatus 100 at the timing of #subframe3 at which the L1/L2 grant is received.

The operation in #subframe4 and #subframe5 will be further described. The mobile station apparatus 200 having transmitted all the reception quality information that was attempted to be transmitted by the multiple PUCCH subframes in response to the L1/L2 grant from the base station apparatus 100, by the single PUSCH subframe in #subframe3, will not transmit any reception quality information in #subframe4 and #subframe5. In illustration of #subframe4, since no L1/L2 grant for permitting the data transmission on the uplink is transmitted from the base station apparatus 100, the mobile station apparatus 200 will not transmit any data on the uplink. That is, the mobile station apparatus 200 having transmitted to the base station apparatus 100 all the reception quality information that was attempted to be transmitted by using the multiple PUCCH subframes will not transmit any reception quality information by the multiple PUCCH subframes that were designated to transmit the reception quality information by the long-term resources assignment from the base station apparatus 100.

In illustration of #subframe5, since the L1/L2 grant for permitting the data transmission on the uplink was transmitted from the base station apparatus 100, the mobile station apparatus 200 having received this signal will not transmit the reception quality information and transmits normal uplink data (e.g., user data) only to the base station apparatus 100. That is, the mobile station apparatus 200 having transmitted to the base station apparatus 100 all the reception quality information that was attempted to be transmitted by using the multiple PUCCH subframes, transmits normal uplink data by the corresponding PUSCH subframe. In case that the mobile station apparatus 200 has transmitted all the reception quality information that was attempted to be transmitted, to the base station apparatus 100 by either of the subframes assigned by the RRC signaling from the base station apparatus 100, the mobile station apparatus 200 will not transmit the reception quality information in other subframes.

#Subframe8, #subframe9 and #subframe10 are the subframes which were designated the mobile station apparatus 200 to transmit the reception quality information by using the multiple PUCCH subframes by the long-term resources assignment from the base station apparatus 100.

In these subframes, the mobile station apparatus 200 transmits the reception quality information by using the multiple PUCCH subframes (three subframes in this case). The mobile station apparatus 200 will transmit the reception quality information, for example, 10 bits in #subframe8, 10 bits in #subframe9 and 10 bits in #subframe10, to the base station apparatus 100.

#Subframe13, #subframe14 and #subframe15 show the same operation as in #subframe3, #subframe4 and #subframe5.

In case that the base station apparatus 100 transmits the L1/L2 grant for permitting the data transmission on the uplink to the subframes (#subframe13, #subframe14 and #subframe15), which were designated by the long-term resources assignment to transmit the reception quality information by using the multiple PUCCH subframes, the mobile station apparatus 200 transmits, to the base station apparatus 100, all the reception quality information that was attempted to be transmitted by using the multiple PUCCH subframes (three subframes, namely #subframe13, #subframe14 and #subframe15), by the corresponding single PUSCH subframe (#subframe13 in this case).

In this case, the mobile station apparatus 200 transmits the reception quality information by using the PUSCH resources assigned by the L1/L2 grant from the base station apparatus 100. In illustration of #subframe13 in FIG. 3, the mobile station apparatus 200 having received the L1/L2 grant from the base station apparatus 100 transmits all the reception quality information that was attempted to be transmitted at this timing in #subframe13, #subframe14 and #subframe15, together with the uplink data, by using PUSCH.

Similarly, the operation in #subframe14 and #subframe15 will be described. The mobile station apparatus 200 having transmitted all the reception quality information that was attempted to be transmitted by using the multiple PUCCH subframes, by the single PUSCH subframe in #subframe13 in response to the L1/L2 grant from the base station apparatus 100, will not transmit any reception quality information in #subframe14 and #subframe15.

In illustration of #subframe14, since the L1/L2 grant for permitting the data transmission on the uplink was transmitted from the base station apparatus 100, the mobile station apparatus 200 having received this signal will not transmit the reception quality information but transmits, to the base station apparatus 100, normal uplink data (e.g., user data).

In illustration of #subframe15, since no L1/L2 grant for permitting the data transmission on the uplink is transmitted from the base station apparatus 100, the mobile station apparatus 200 will not transmit any data on the uplink.

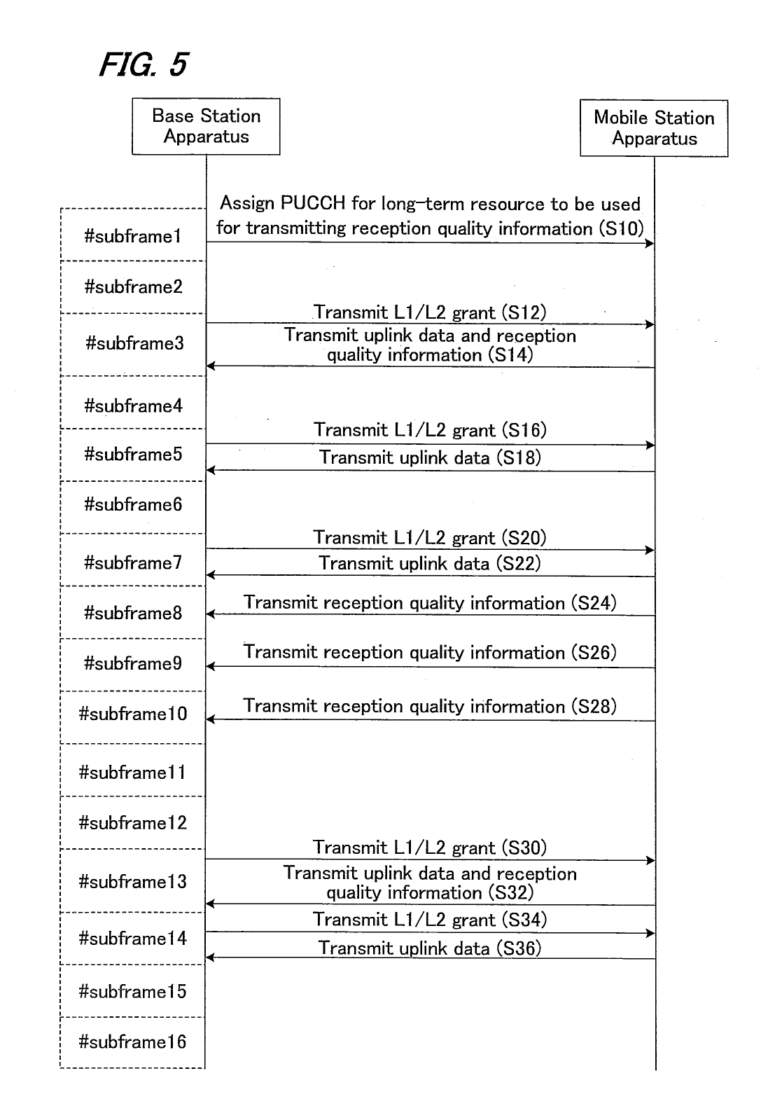

Next, the operation and process in the present embodiment will be described with reference to FIG. 5. First, in #subframe1, the base station apparatus 100 performs the long-term resources assignment of PUCCH to be used by the mobile station apparatus 200 for transmitting the reception quality information (S10). The base station apparatus 100 designates to the mobile station apparatus 200 periodicity for transmission of the reception quality information, offset for transmission of the reception quality information, and the number of PUCCH subframes to be used for transmitting the reception quality information.

In the present embodiment, the base station apparatus 100 designates the mobile station apparatus 200 to transmit the reception quality information with a five-subframe period, a two-subframe offset, and three PUCCH subframes to be used. The mobile station apparatus 200 having received this signal transmits the reception quality information by using the multiple PUCCH subframes designated by the base station apparatus 100.

In #subframe3, the base station apparatus 100 transmits the L1/L2 grant for permitting the data transmission on the uplink (S12). The mobile station apparatus 200 having received this signal transmits all the reception quality information that was attempted to be transmitted by using PUCCH in #subframe3, #subframe4 and #subframe5 under instructions from the base station apparatus 100, by using the single PUSCH subframe in #subframe3 (S14).

For example, the mobile station apparatus 200 that was attempted to transmit the reception quality information by using PUCCH, 10 bits in #subframe3, 10 bits in #subframe4 and 10 bits in #subframe5, will transmit the reception quality information of 30 bits by using PUSCH in #subframe3.

In #subframe4, the mobile station apparatus 200 having received no L1/L2 grant for permitting the data transmission on the uplink from the base station apparatus 100 will not transmit anything. That is, the mobile station apparatus 200 having transmitted in #subframe3 to the base station apparatus 100 all the reception quality information that was attempted to be transmitted by using the multiple PUCCH subframes will not transmit any reception quality information by using the multiple PUCCH subframes that were designated to transmit the reception quality information by the long-term resources assignment from the base station apparatus 100.

In #subframe5, the base station apparatus 100 transmits the L1/L2 grant for permitting the data transmission on the uplink (S16). The mobile station apparatus 200 having received this signal does not transmit the reception quality information and transmits, to base station apparatus 100, normal uplink data (e.g., user data) (S18). That is, when the mobile station apparatus 200 having transmitted in #subframe3, to the base station apparatus 100, all the reception quality information that was attempted to be transmitted by using the multiple PUCCH subframes receives the L1/L2 grant for permitting the data transmission on the uplink, the mobile station apparatus transmits normal uplink data by the PUSCH subframe corresponding to the multiple PUCCH subframes designated to transmit the reception quality information by the long-term resources assignment from the base station apparatus 100.

In #subframe7, the base station apparatus 100 transmits the L1/L2 grant for permitting the data transmission on the uplink (S20). The mobile station apparatus 200 having received this signal transmits, to base station apparatus 100, normal uplink data (e.g., user data) (S22).

In #subframe8, #subframe9 and #subframe10, the mobile station apparatus 200 transmits the reception quality information by using the multiple PUCCH subframes, based on the long-term resources assignment from the base station apparatus 100 in #subframe1. For example, the mobile station apparatus transmits the reception quality information, 10 bits in #subframe8 (S24), 10 bits in #subframe9 (S26) and 10 bits in #subframe10 (S28), by using three PUCCH subframes. The base station apparatus 100, based on the reception quality information of 30 bits in total, transmitted from the mobile station apparatus 200, performs the processes of the adaptive modulation and coding scheme or the frequency selective scheduling upon the information to be transmitted on the downlink.

The same operation as that of #subframe3 is performed in #subframe13. That is, the base station apparatus 100 transmits the L1/L2 grant for permitting the data transmission on the uplink in #subframe13 (S30). The mobile station apparatus 200 having received this signal transmits all the reception quality information that was attempted to be transmitted by using three PUCCH subframes (#subframe13, #subframe14 and #subframe15) designated by the base station apparatus 100, by using the single PUSCH subframe (S32). For example, the mobile station apparatus 200 that was attempted to transmit the reception quality information, 10 bits in #subframe13, 10 bits in #subframe14 and 10 bits in #subframe15, by using PUCCH, will transmit the reception quality information of 30 bits in #subframe13 by using PUSCH.

The same operation as that of #subframe5 is performed in #subframe14. The base station apparatus 100 transmits the L1/L2 grant for permitting the data transmission on the uplink in #subframe14 (S34). The mobile station apparatus 200 having received this signal will not transmit the reception quality information but transmits, to base station apparatus 100, normal uplink data (e.g., user data) (S36).

The same operation as that of #subframe4 is performed in #subframe15. In #subframe15, the mobile station apparatus 200 having received no L1/L2 grant for permitting the data transmission on the uplink from base station apparatus 100 will not transmit anything. That is, the mobile station apparatus 200 having transmitted, to base station apparatus 100, all the reception quality information that was attempted to be transmitted by using the multiple subframes will not transmit any reception quality information in #subframe15 by using the PUCCH subframes that were designated to transmit the reception quality information by the long-term resources assignment from the base station apparatus 100.

In FIG. 4, the transmission format in #subframe3 represented with a lattice pattern and dot pattern (A1) shows that mobile station apparatus 200 is transmitting all the reception quality information that was attempted to be transmitted by using the multiple PUCCH subframes, together with the uplink data by using the single PUSCH subframe.

The transmission format in #subframe5 represented by a dot pattern (B1) shows that the mobile station apparatus 200 is transmitting, to the base station apparatus 100, normal uplink data (e.g., user data) by using PUSCH.

Further, the transmission format in #subframe8 represented by hatching (C1) shows that the mobile station apparatus is transmitting the reception quality information by using PUCCH, in accordance with the long-term assignment of PUCCH designated in #subframe1.

The transmission format in #subframe13 represented with a lattice pattern and dot pattern (D1), similarly to #subframe3, shows that the mobile station apparatus 200 is transmitting all the reception quality information that was attempted to be transmitted by using the multiple PUCCH subframes, together with the uplink data by using the single PUSCH subframe.

In this way, in case that the base station apparatus 100 transmits the L1/L2 grant for permitting the data transmission on the uplink, to multiple PUCCH subframes assigned to transmit the reception quality information, the mobile station apparatus 200 having received this signal transmits the reception quality information that was attempted to be transmitted by using the multiple PUCCH subframes, by using the corresponding single PUSCH subframe, whereby it is possible to reduce the processes when the reception quality information is transmitted and received between the base station apparatus 100 and the mobile station apparatus 200.

The base station apparatus 100 does not need to separately decode different reception quality information transmitted from the mobile station apparatus 200 through different channels (PUSCH and PUCCH), but can perform the processes of the adaptive modulation control and the frequency selective scheduling upon the information to be transmitted on the downlink, based on the reception quality information transmitted by using the single PUSCH subframe.

Further, it is possible to transmit the reception quality information that was attempted to be transmitted by using the multiple PUCCH subframes, by using the single PUSCH subframe, hence it is possible to reduce the delay until the reception quality information is transmitted from the mobile station apparatus 200 to the base station apparatus 100. By transmitting the reception quality information from the mobile station apparatus 200 by using the single PUSCH subframe, the mobile station apparatus 200 enables transmission of the reception quality information more closely following the state of the current transmission channel, hence it is possible for base station apparatus 100 to perform the adaptive modulation and coding scheme or the frequency selection scheduling, in a suited manner to the conditions of the transmission channel, upon the information to be transmitted on the downlink.

### The Second Embodiment

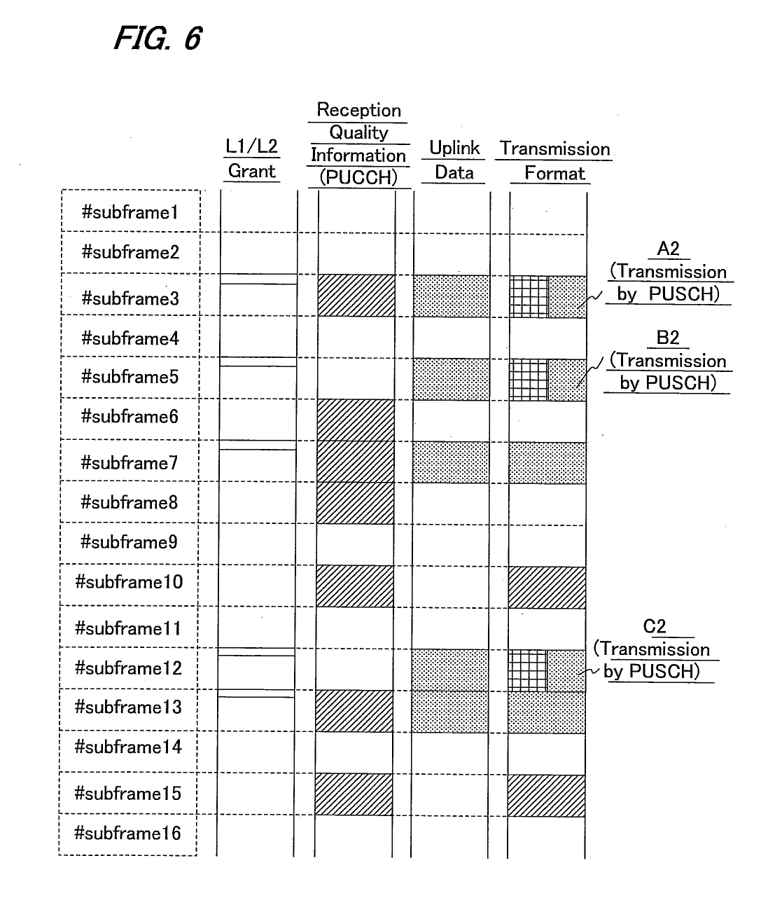

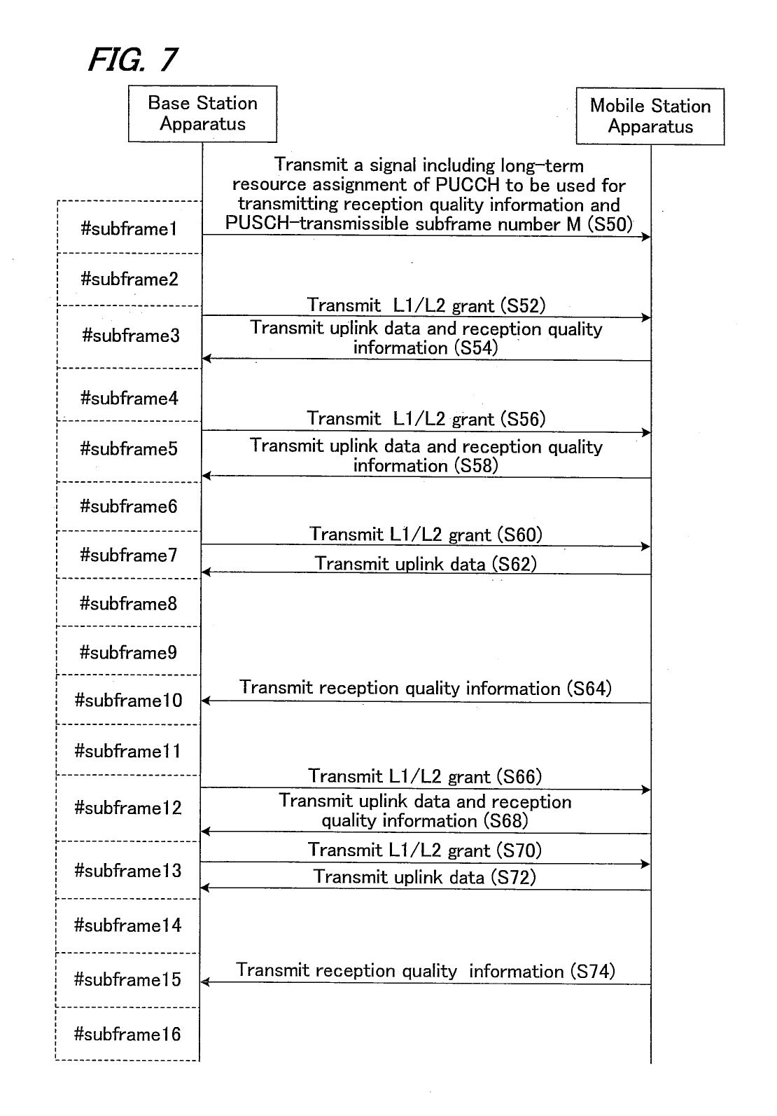

Next, the second embodiment will be described with reference to FIGS. 6 and 7. The second embodiment provides an embodied mode in which the base station apparatus 100 transmits the long-term resources assignment of PUCCH to be used for transmitting the reception quality information and the PUSCH-transmissible subframe number M for setting the number of PUCCH subframes for the reception quality information that can be transmitted by the single PUSCH subframe, and in case that the base station apparatus transmits the L1/L2 grant for permitting the data transmission on the uplink, the mobile station apparatus 200 transmits, to base station apparatus 100, the reception quality information that was attempted to be transmitted by PUCCH subframes equal to or smaller in number than the number set by the PUSCH-transmissible subframe number, by the corresponding single PUSCH subframe.

The operation will be illustrated by mainly describing the characteristic subframes of the present embodiment with reference to FIG. 6. In #subframe1, the base station apparatus 100 transmits the long-term resources assignment of PUCCH to be used for transmitting the reception quality information and the PUSCH-transmissible subframe number M which sets the number of PUCCH subframes that is designated to be used to transmit the reception quality information and can be transmitted by the single PUSCH subframe. The long-term resources assignment for transmitting the reception quality information by using PUCCH subframes and the number of PUSCH-transmissible subframes, set by the base station apparatus 100, is included in the RRC signaling, for example.

In #subframe1, the base station apparatus 100 sets, to mobile station apparatus 200, the transmission of the reception quality information by using PUCCH subframes (5 subframe period, 2 subframe offset, 1 PUCCH subframe), in addition sets the number of PUSCH-transmissible subframes, M=2.

In #subframe5, the mobile station apparatus 200 having received, from base station apparatus 100, the L1/L2 grant for permitting the data transmission on the uplink, transmits the reception quality information that was attempted to be transmitted by PUCCH subframes equal to or smaller in number than the number of subframes (M=2) set by the PUSCH-transmissible subframe number. That is, the reception quality information that was attempted to be transmitted by subframes equal to or smaller in number than M=2, namely #subframe6, is transmitted to the base station apparatus 100 by using the single PUSCH subframe.

That is, in #subframe6, all the reception quality information that has occupied three PUCCH subframes (#subframe6, #subframe7 and #subframe8) under instructions from the base station apparatus 100 is transmitted by using the single PUSCH subframe.

In #subframe12, the mobile station apparatus 200 having received, from the base station apparatus 100, the L1/L2 grant for permitting the data transmission on the uplink, transmits the reception quality information that was attempted to be transmitted by PUCCH subframes equal to or smaller in number than the number of subframes (M=2) set by the PUSCH-transmissible subframe number. That is, the reception quality information that was attempted to be transmitted by subframes up to as many as, or less than M=2, namely #subframe13, is transmitted to the base station apparatus 100 by using the single PUSCH subframe.

In illustration of #subframe13, since the L1/L2 grant for permitting the data transmission on the uplink was transmitted from the base station apparatus 100, the mobile station apparatus 200 having received this signal will not transmit the reception quality information and transmits, to base station apparatus 100, normal uplink data (e.g., user data) only. That is, since the reception quality information that was attempted to be transmitted by using PUCCH subframes has been already transmitted to the base station apparatus 100 in #subframe12, normal uplink data only is transmitted by the corresponding PUSCH subframe in #subframe13.

Next, the operation and process in the present embodiment will be described with reference to FIG. 7. First, in #subframe1, the base station apparatus 100 sets the long-term resources assignment of PUCCH for the mobile station apparatus 200 to transmit the reception quality information and the PUSCH-transmissible subframe number M (S50). The example herein shows that the mobile station apparatus 200 is designated to transmit the reception quality information with a three-subframe period, a two-subframe offset, and one PUCCH subframe to be used. Further, the number of PUSCH-transmissible subframes is assumed to be set to M=2.

In #subframe3, the base station apparatus 100 transmits the L1/L2 grant for permitting the data transmission on the uplink (S52). The mobile station apparatus 200 having received this signal transmits, to base station apparatus 100, the reception quality information that was attempted to be transmitted by PUCCH and the uplink data (e.g., user data), by using PUSCH (S54).

In #subframe5, the base station apparatus 100 transmits the L1/L2 grant for permitting the data transmission on the uplink (S56). With setup of the number of PUSCH-transmissible subframes at M=2, the mobile station apparatus 200 having received this signal transmits the reception quality information that was attempted to be transmitted in #subframe6 by PUCCH and the uplink data, by using PUSCH subframe (S58).

At this point, the mobile station apparatus 200 transmits all the reception quality information that was designated by the base station apparatus 100 to be transmitted by using PUCCH in #subframe6, #subframe7 and #subframe8, by using the single PUSCH subframe in #subframe5.

#Subframe6 is a subframe that was assigned by the base station apparatus 100 in #subframe1, as the long-term resources for transmitting the reception quality information by using PUCCH. Based on the setting of the number of PUSCH-transmissible subframes from the base station apparatus 100, the mobile station apparatus 200 having transmitted the reception quality information in #subframe5 will not transmit anything in #subframe 6. That is, the mobile station apparatus will not transmit the reception quality information by the PUCCH subframes that were designated, in #subframe1, to transmit the reception quality information by the long-term resources assignment from the base station apparatus 100.

In #subframe7, the base station apparatus 100 transmits the L1/L2 grant for permitting the data transmission on the uplink (S60). The mobile station apparatus 200 having received this signal transmits to base station apparatus 100, normal uplink data (S62). Based on the setting of the number of PUSCH-transmissible subframes from the base station apparatus 100, the mobile station apparatus 200 having transmitted the reception quality information in #subframe5 will not transmit the reception quality information in #subframe7.

#Subframe8 is a subframe that was assigned by the base station apparatus 100 in #subframe1, as the long-term resources for transmitting the reception quality information by using PUCCH. Based on the setting of the number of PUSCH-transmissible subframes from the base station apparatus 100, the mobile station apparatus 200 having transmitted the reception quality information in #subframe5 will not transmit anything in #subframe8.

#Subframe10 is a subframe that was assigned by the base station apparatus 100 in #subframe1, as the long-term resources for transmitting the reception quality information by using PUCCH. The mobile station apparatus 200 transmits the reception quality information, by using the PUCCH resources assigned from the base station apparatus 100 (S64). The same operation is carried out also in #subframe15 (S74).

In #subframe12, the base station apparatus 100 transmits the L1/L2 grant for permitting the data transmission on the uplink (S66). With setup of the number of PUSCH-transmissible subframes at M=2, the mobile station apparatus 200 having received this signal transmits the reception quality information that was attempted to be transmitted in #subframe13 by using PUCCH and the uplink data, by using PUSCH subframe (S68).

In #subframe13, the base station apparatus 100 transmits the L1/L2 grant for permitting the data transmission on the uplink (S70). Based on the setting of the number of PUSCH-transmissible subframes from the base station apparatus 100, the mobile station apparatus 200 having transmitted the reception quality information in #subframe12 transmits the uplink data only in #subframe13.

In FIG. 6, the transmission format in #subframe3 represented with a lattice pattern and dot pattern (A2) shows that the mobile station apparatus 200 is transmitting, to base station apparatus 100, the reception quality information that was attempted to be transmitted by PUCCH and the uplink data (e.g., user data), by using PUSCH. The transmission format in #subframe5 represented with a lattice pattern and dot pattern (B2) shows that the mobile station apparatus 200 is transmitting the reception quality information that was attempted to be transmitted by PUCCH subframes equal to or smaller in number than the number of subframes set by the PUSCH-transmissible subframe number, together with the uplink data, by using the PUSCH subframe.

Also, the transmission format in #subframe12 represented with a lattice pattern and dot pattern (C2) shows that the mobile station apparatus 200 is transmitting the reception quality information that was attempted to be transmitted by PUCCH subframes equal to or smaller in number than the number of subframes set by the PUSCH-transmissible subframe number, together with the uplink data, by using the PUSCH subframe.

In this way, according to the second embodiment, in case that the base station apparatus 100 transmits the long-term resources assignment of PUCCH to be used for transmitting the reception quality information and the PUSCH-transmissible subframe number for setting the number of PUCCH subframes for the reception quality information that can be transmitted by the PUSCH subframe, and further in case that the base station apparatus transmits the L1/L2 grant for permitting the data transmission on the uplink, the mobile station apparatus 200 transmits, to base station apparatus 100, the reception quality information that was attempted to be transmitted by PUCCH subframes equal to or smaller in number than the number of subframes set by the PUSCH-transmissible subframe number, by the corresponding PUSCH subframe, whereby it is possible to effectively use PUCCH resources through which information cannot be transmitted to many mobile station apparatuses 20 simultaneously because the resources area assigned by the base station apparatus 100 is small.

Further, since the base station apparatus 100 is able to control the mobile station apparatus 200 to transmit the reception quality information that was attempted to be transmitted by using PUCCH, by using PUSCH, it is possible to assign the freed PUCCH resources to other mobile station apparatuses 200. For example, in a case where there are many mobile station apparatuses 200 in the cell controlled by the base station apparatus 100, when the reception quality information that was attempted to be transmitted by using PUCCH (1) from a certain mobile station apparatus, is controlled to be transmitted by using PUSCH, it is possible to assign the freed PUCCH (1) resources to another mobile station apparatus. As a result, if the amount of information (control information) to be transmitted from many mobile station apparatuses by using PUCCH has become bulky, shortage of PUCCH resources in the whole cell can be relieved, hence it is possible to perform flexible communication control (scheduling) for more mobile station apparatuses.

Though the embodiments of this invention have been described in detail heretofore with reference to the drawings, the specific configuration is not limited to the embodiments, and designs etc. that will not depart from the spirit of the present invention should be included in the scope of Claims.

1-5. (canceled)

6. A mobile station apparatus that transmits, to a base station apparatus, reception quality information in a frequency band of a wideband that consists of a frequency bands of a narrowband, by transmitting multiple reception quality information in the frequency band of the narrowband by an uplink control channel (PUCCH), by using multiple subframes assigned on a long term basis,
wherein the multiple subframes are designated, by the base station apparatus, to transmit the reception quality information in the frequency band of the narrowband by the uplink control channel (PUCCH), and,
in case of receiving, from the base station apparatus, an uplink data transmission grant signal for assigning an uplink data channel (PUSCH) that is mapped in any of the multiple subframes designated to transmit the reception quality information in the frequency band of the narrowband by the uplink control channel (PUCCH),
transmits, to the base station apparatus, the reception quality information in the frequency band of the wideband, by using a single subframe of the uplink data channel (PUSCH).

7. The mobile station apparatus according to claim 6, wherein the reception quality information in the frequency band of the wideband is transmitted together with an uplink data to the base station apparatus.

8. A communication method for a mobile station apparatus that transmits, to a base station apparatus, reception quality information in a frequency band of a wideband that consists of a frequency bands of a narrowband, by transmitting multiple reception quality information in the frequency band of the narrowband by an uplink control channel (PUCCH), by using multiple subframes assigned on a long term basis,
wherein the multiple subframes are designated, by the base station apparatus, to transmit the reception quality information in the frequency band of the narrowband by the uplink control channel (PUCCH), and,
in case of receiving, from the base station apparatus, an uplink data transmission grant signal for assigning an uplink data channel (PUSCH) that is mapped in any of the multiple subframes designated to transmit the reception quality information in the frequency band of the narrowband by the uplink control channel (PUCCH),
transmits, to the base station apparatus, the reception quality information in the frequency band of the wideband, by using a single subframe of the uplink data channel (PUSCH).

9. The communication method according to claim 8, wherein the reception quality information in the frequency band of the wideband is transmitted together with uplink data to the base station apparatus.
